(19) United States
(12) Patent Application Publication
(10) Pub. No.: US 2026/0344686 A1
(43) Pub. Date: Nov. 5, 2026

(54) BAKED GOODS ENHANCER AND METHODS OF MAKING AND USING THE SAME

(71) Applicant: Caravan Ingredients Inc., Lenexa, KS (US)

(72) Inventors: Ashley Geoghegan Beech, Lenexa, KS (US); Eric Ralph Spelger, Lenexa, KS (US); Yanling Linsey Yin, Lenexa, KS (US)

(21) Appl. No.: 19/486,659

(22) PCT Filed: May 22, 2024
(86) PCT No.: PCT/US2024/030605

§ 371 Date: Nov. 21, 2025

Related U.S. Application Data
(60) Provisional application No. 63/503,572, filed on May 22, 2023.

(51) Int. Cl. A21D 13/045; A21D 2/18; A21D 2/26; A21D 8/04

(52) U.S. Cl. CPC A21D 13/045; A21D 2/183; A21D 2/185; A21D 2/265; A21D 2/266; A21D 8/042

(57) ABSTRACT

The present disclosure is directed to compositions comprising inter alia, a pulse flour, a soluble plant protein, a hydrocolloid, an insoluble plant protein, and one or more hydrolytic enzymes and use thereof, such as baked goods enhancer compositions. This baked goods enhancer is particularly well suited for bakery applications such as yeast-raised goods including bread, rolls, sweet baked goods, etc. Use of this baked goods enhancer enables a reduction of both whole eggs and oil in such baked goods.

### CROSS-REFERENCE TO RELATED APPLICATIONS

The present application claims the priority benefit of U.S. Provisional Patent Application Ser. No. 63/503,572, filed May 22, 2023, entitled BAKED GOODS ENHANCER AND METHODS OF MAKING AND USING THE SAME, the entirety of which is incorporated by reference herein.

### BACKGROUND

### Field

The present disclosure is directed to; inter alia, compositions that enhance the operational and nutritional profiles of baked goods, methods of manufacturing said enhancers, and methods of using said enhancer compositions as ingredients in the preparation of food products.

### Description of Related Art

Baked goods are globally enjoyed by consumers everywhere and yet subject to price volatility in the various ingredients used to manufacture those baked goods. Additionally, consumers often prefer baked goods with nutritional profiles that align with health goals. Eggs and oils are important food ingredients in baked goods and often contribute to the operational and nutritional profiles of baked goods. Eggs and oils offer nutritional value and provide various functionalities when used as ingredients in food products. Some of the functionalities provided by eggs include texturizing, emulsifying, water retention, among others. And some of the functionalities provided by fats include softness, moistness, among others.

Many attempts have been made to create egg and oil replacer compositions that provide the desired nutritional and functional features of eggs and oil. Often these replacement options involve an egg replacer that is separate from the oil replacer which requires extensive development work to get the benefit of both replacers. Additionally, these existing egg and oil replacers have deficiencies including operational difficulties and the need to compensate for missing functionalities.

Thus, there is a need for a combined egg and oil replacer that can enhance the operational and nutritional profile of baked goods.

### SUMMARY

In some embodiments, these inventors have developed an inventive baked goods enhancer composition comprising from about 45% to about 70% of a pulse flour, from about 10% to about 25% of a soluble plant protein, from about 5% to about 15% of a hydrocolloid, from about 3% to about 17% of an insoluble plant protein, and from about 0.01 to about 0.20% of a hydrolytic enzyme, wherein all percentages are w/w by weight of the baked goods enhancer composition. In some embodiments, the hydrolytic enzyme can include a lipase, a phospholipase, an amylase, a xylanase, a cellulase, and combinations thereof. For ease of use, in some embodiments, the baked goods enhancer composition is in powdered form. In other embodiments, the weight ratio of pulse flour to insoluble plant protein in the baked goods enhancer composition is from about 2:1 to about 25:1.

In some embodiments, the inventions include a food product comprising from about 0.01% to about 20% of a baked goods enhancer composition comprising from about 45% to about 70% of a pulse flour, from about 10% to about 25% of a soluble plant protein, from about 5% to about 15% of a hydrocolloid, from about 3% to about 17% of an insoluble plant protein, and from about 0.01 to about 0.20% of a hydrolytic enzyme.

In some embodiments, the inventors have also developed a method of making a baked goods enhancer composition comprising the steps of adding from about 45% to about 70% of a pulse flour, from about 10% to about 25% of a soluble plant protein, from about 5% to about 15% of a hydrocolloid, from about 3% to about 17% of an insoluble plant protein, and from about 0.01% to about 0.20% of a hydrolytic enzyme to a dry blender and blending until homogenous.

In other embodiments, the inventions can include a method of adjusting a food formulation comprising the steps of replacing from about 20% to about 50% of an amount of whole egg in the food formulation with an amount of from about 0.01% to about 20% (based on weight of the food formulation) of a baked goods enhancer composition comprising from about 45% to about 70% of a pulse flour, from about 10% to about 25% of a soluble plant protein, from about 5% to about 15% of a hydrocolloid, from about 3% to about 17% of an insoluble plant protein, and from about 0.01 to about 0.20% of a hydrolytic enzyme wherein all percentages for the baked goods enhancer composition are w/w by weight of the baked goods enhancer composition. In some embodiments, the method of adjusting a food formulation further comprises the step of replacing from about 20% to about 50% of an amount of oil in the food formulation with an amount of from about 0.01% to about 20% of a baked goods enhancer composition of the baked goods enhancer composition (percentage based on weight of the food formulation) comprising from about 45% to about 70% of a pulse flour, from about 10% to about 25% of a soluble plant protein, from about 5% to about 15% of a hydrocolloid, from about 3% to about 17% of an insoluble plant protein, and from about 0.01 to about 0.20% of a hydrolytic enzyme wherein all baked goods enhancer percentages are w/w by weight of the baked goods enhancer composition.

In some embodiments, the disclosure provides a baked goods enhancer composition comprising from about 45% to about 70% of a pulse flour, from about 10% to about 25% of a soluble plant protein, from about 5% to about 15% of a hydrocolloid, from about 3% to about 17% of an insoluble plant protein, and from about 0.01% to about 0.20% of a hydrolytic enzyme, wherein all percentages are w/w by weight of the baked goods enhancer composition. The hydrolytic enzyme includes a three-way enzyme blend comprising respective effective amounts of each of a maltogenic amylase, a lipase, and a xylanase, and respective weights of each of a maltogenic amylase, a lipase, and a xylanase. One or both of the following are true:
the ratio of the effective amount of maltogenic amylase to the effective amount of lipase is from about 150:1 to about 500:1; or
the weight ratio of maltogenic amylase to lipase is from about 0.25:1 to about 4:1.

The disclosure also provides a food product comprising from about 0.01% to about 20% of a baked goods enhancer composition, based on w/w by weight of the food product. The baked goods enhancer comprises from about 45% to about 70% of a pulse flour, from about 10% to about 25% of a soluble plant protein, from about 5% to about 15% of a hydrocolloid, from about 3% to about 17% of an insoluble plant protein, and from about 0.01% to about 0.20% of a hydrolytic enzyme, based on w/w by weight of the baked goods enhancer composition. The hydrolytic enzyme includes a three-way enzyme blend comprising respective effective amounts of each of a maltogenic amylase, a lipase, and a xylanase, and respective weights of each of a maltogenic amylase, a lipase, and a xylanase. One or both of the following are true:
the ratio of the effective amount of maltogenic amylase to the effective amount of lipase is from about 150:1 to about 500:1; or
the weight ratio of maltogenic amylase to lipase is from about 0.25:1 to about 4:1.

A method of adjusting a food formulation is also provided. The method comprises replacing from about 20% to about 50% of an amount of whole eggs and from about 20% to about 50% of an amount of oil in the food formulation with an amount of from about 0.01% to about 20% of a baked goods enhancer composition, based on w/w by weight of the food product. The baked goods enhancer composition comprises from about 45% to about 70% of a pulse flour, from about 10% to about 25% of a soluble plant protein, from about 5% to about 15% of a hydrocolloid, from about 3% to about 17% of an insoluble plant protein, and from about 0.01% to about 0.20% of a hydrolytic enzyme, based on w/w by weight of the baked goods enhancer composition. The hydrolytic enzyme includes a three-way enzyme blend comprising respective effective amounts of each of a maltogenic amylase, a lipase, and a xylanase, and respective weights of each of a maltogenic amylase, a lipase, and a xylanase. One or both of the following are true:
the ratio of the effective amount of maltogenic amylase to the effective amount of lipase is from about 150:1 to about 500:1; or
the weight ratio of maltogenic amylase to lipase is from about 0.25:1 to about 4:1.

In further embodiments, the disclosure provides a baked goods enhancer composition comprising a pulse flour, a soluble plant protein, an insoluble plant protein, a hydrocolloid, and a hydrolytic enzyme.

The disclosure also provides a method of forming a food product wherein the method comprises mixing a baked goods enhancer composition with other ingredients to form the food product. The baked goods enhancer composition comprises a pulse flour, a soluble plant protein, an insoluble plant protein, a hydrocolloid, and a hydrolytic enzyme.

In yet a further embodiment, the disclosure is directed towards a food product comprising a baked goods enhancer composition comprising a pulse flour, a soluble plant protein, an insoluble plant protein, a hydrocolloid, and a hydrolytic enzyme.

### DETAILED DESCRIPTION

### Baked Goods Enhancer Compositions

These inventors have surprisingly found a way to replace both whole eggs and oil in baked goods without using processed ingredients such as emulsifiers. According to some embodiments, a baked goods enhancer composition comprises from about 45% to about 70% of a pulse flour, from about 10% to about 25% of a soluble plant protein, from about 5% to about 15% of a hydrocolloid, from about 3% to about 17% of an insoluble plant protein, and from about 0.01% to about 0.20% of a hydrolytic enzyme wherein all percentages are w/w by weight of the baked goods enhancer composition. A baked goods enhancer composition having this inventive composition has additional benefits reducing quantities of both eggs and oils in baked goods and not provoking allergic reactions associated with some egg substitute ingredients such as soy, peanut, and dairy ingredients.

To be able to replace both eggs and oils without processed ingredients such as emulsifiers, a careful balance of components is needed. Thus, in some embodiments, the baked goods enhancer composition comprises pulse flour and insoluble plant protein in a w/w ratio of from about 2:1 to about 25:1, preferably 3:1 to 15:1, more preferably 4:1 to 12:1, and most preferably from 3:1 to 5:1. In some embodiments, the baked goods enhancer composition comprises pulse flour and insoluble plant protein in a w/w ratio of about 2:1, 2.5:1, 3:1, 5:1, 8:1, 10:1, 12:1, 15:1, 17:1, 20:1, 22:1, 23:1, or 25:1.

In some embodiments, a baked goods enhancer composition further comprises other flours. As used herein, “other flours” can include wheat flours including whole wheat flours, semolina flour, durum flour and the like, corn flours, cereal flours, and combinations thereof. In embodiments that include other flours, the other flour can be selected for functionalities such as structural support, etc. as desired for the food product involved.

In some embodiments, a baked goods enhancer composition as described herein is in powdered form. In some embodiments, the powdered baked goods enhancer composition as described herein has a longer shelf-life as compared to prior art compositions. For example, the baked goods enhancer composition can be stored at ambient conditions (e.g., about 15 °C to about 30 °C) for at least about 3 months, preferably at least about 6 months, more preferably at least about 9 months, and even more preferably about 12 months to about 18 months without the baked goods enhancer composition and/or food product containing the baked goods enhancer composition experiencing any adverse consequences, such as spoilage and/or decrease in performance.

In some embodiments, the powdered baked goods enhancer composition as described herein has a specific gravity of from about 0.40 to about 0.60 g/cc, and preferably about 0.47 g/cc to about 0.52 g/cc, as measured by specific gravity cup and weight of water.

### 1. Pulse Flour

In some embodiments, the pulse flour includes a lentil flour, a broad bean flour, a chickpea flour, a fava bean flour, a black bean flour, a kidney bean flour, a navy bean flour, a pinto bean flour, a mung bean flour, a lima bean flour, an adzuki bean flour, or combinations thereof. As used herein, “pulse flour” refers to a powder ground from grains, seeds, roots, or other sources.

In some embodiments including chickpea flour, the chickpea flour has a protein content of less than about 25% w/w, preferably from about 10% to about 20% w/w, and more preferably from about 15% to about 20% w/w by weight of the chickpea flour. In some embodiments including chickpea flour, the chickpea flour has a total carbohydrate content of from about 60% to about 85% w/w by weight of the chickpea flour. In some embodiments including chickpea flour, the chickpea flour has a soluble fiber content of from about 5% to about 10% w/w by weight of the chickpea flour.

In one or more embodiments, the pulse flour comprises less than about 25% w/w total protein, preferably less than about 20% w/w total protein, and more preferably less than about 15% w/w total protein, based on the weight of the pulse flour. In the same or different embodiments, the pulse flour comprises at least about 50% w/w total carbohydrate content, preferably at least about 60% w/w total carbohydrate content, and more preferably at least about 70% w/w total carbohydrate content, based on the weight of the pulse flour.

In some embodiments, the baked goods enhancer composition comprises at least about 45% (w/w) pulse flour, and preferably from about 45% to 70% (w/w) pulse flour. In some embodiments, the baked goods enhancer composition comprises pulse flour in amounts of from about 45%, 50%, 55%, 60, or 65%, (w/w) to about 50%, 55%, 60%, 65% or 70% (w/w), including any range therebetween. In other embodiments, the baked goods enhancer composition comprises pulse flour in amounts of from about 45% to about 50% (w/w), from about 45% to about 55% (w/w), from about 45% to about 60% (w/w), from about 50% to about 55% (w/w), from about 50% to about 60% (w/w), from about 50% to about 65% (w/w), from about 55% to about 60% (w/w), from about 55% to about 65% (w/w), from about 60% to about 65% (w/w), and from about 65% to about 70% (w/w) pulse flour, including any range therebetween.

In still other embodiments, the baked goods enhancer composition comprises at least about 40% (w/w), at least about 45% (w/w), at least about 50% (w/w), at least about 55% (w/w), at least about 60% (w/w), of pulse flour, including any value therebetween.

### 2. Soluble Plant Protein

In some embodiments, the soluble plant protein includes a rice protein, a pea protein, a charantia protein, a walnut protein, a corn protein, a mung bean protein, or combinations thereof. As used herein, the term “protein” refers to organic compounds made of amino acids arranged in a linear chain. As used herein, the term “soluble plant protein” refers to a plant-based protein that dissolves within about 5 minutes in about 25 °C water at a concentration of at least 50% w/v.

In some embodiments, the weight ratio of pulse flour to soluble plant protein can be from about 0.5:1 to about 10:1, preferably about 1:1 to about 7:1, more preferably about 2:1 to about 5:1, and most preferably about 2.5:1 to about 3:1.

In some embodiments including pea protein, the pea protein has a protein content of at least about 75%. In some embodiments including pea protein, the pea protein has a viscosity of less than about 550 cps when measured by rotational viscometer in a 10-50% solution. In some embodiments, the soluble plant protein can include isolates, concentrates, or combinations thereof.

In one or more embodiments, the soluble plant protein comprises at least about 60% w/w total protein content, preferably at least about 70% w/w total protein content, more preferably at least about 80% w/w total protein content, even more preferably at least about 90% w/w total protein content, and most preferably at least about 95% w/w total protein content, based on the weight of the soluble plant protein. In the same or different embodiments, the soluble plant protein comprises less than about 25% w/w total carbohydrates, preferably less than about 15% w/w total carbohydrates, more preferably less than about 10% w/w total carbohydrates, even more preferably less than about 5% w/w total carbohydrates, and most preferably less than about 2% w/w total carbohydrates, based on the weight of the soluble plant protein.

In some embodiments, the baked goods enhancer composition comprises from about 10% (w/w) to about 25% (w/w) of a soluble plant protein. In some embodiments, the composition comprises from about 10%, 12%, 15%, 17%, 20%, or 22% (w/w) to about 12%, 15%, 17%, 20%, 22%, or 25% (w/w) soluble plant protein, including any range therebetween. In other embodiments, the baked goods enhancer composition comprises soluble plant protein in amounts of from about 10% to about 12% (w/w), from about 10% to about 15% (w/w), from about 10% to about 17% (w/w), from about 10% to about 20% (w/w), from about 10% to about 22% (w/w), from about 10% to about 25% (w/w), from about 12% to about 15% (w/w), from about 12% to about 17% (w/w), from about 12% to about 20% (w/w), from about 12% to about 22% (w/w), from about 12% to about 25% (w/w), from about 15% to about 17% (w/w), from about 15% to about 20% (w/w), from about 15% to about 22% (w/w), from about 15% to about 25% (w/w), from about 17% to about 20% (w/w), from about 17% to about 22% (w/w), from about 17% to about 25% (w/w), from about 20% to about 22% (w/w), from about 20% to about 25% (w/w), soluble plant protein, including any value therebetween.

In still other embodiments, the baked goods enhancer composition comprises at least about 10% (w/w), at least about 12%, at least about 15%, at least about 17%, at least about 20%, or at least about 22% (w/w) of soluble plant protein, including any value therebetween.

### 3. Hydrocolloid

In some embodiments, the hydrocolloid can include a xanthan gum, an alginate gum, a carboxymethyl cellulose (CMC), a carrageenan gum, an agar gum, a guar gum, or combinations thereof. As used herein, the term “hydrocolloid” refers to any material that thickens and/or forms a gel when mixed with water, typically at temperature of about 25 °C.

In some embodiments, the hydrocolloid includes a carboxymethyl cellulose that has a degree of substitution of from about 0.5 to about 1. In some embodiments, the hydrocolloid includes a 1% w/v solution of carboxymethyl cellulose that has a viscosity of from about 1300 to about 3500 cps when measured by rotational viscometer.

In embodiments including xanthan gum as a hydrocolloid, a 1% potassium chloride solution of the xanthan gum can have a viscosity of about 1200 to about 1600 cps.

In embodiments including guar gum as a hydrocolloid, a 1% solution of the guar gum can have a viscosity of at least about 5500 cps when measured at 25 °C after 2 hours.

In some embodiments, the baked goods enhancer composition comprises from about 5% to about 15% of a hydrocolloid. In some embodiments, the baked goods enhancer composition comprises from about 5%, 6%, 7%, 8%, 9%, 10%, 11%, 12%, 13%, or 14% (w/w) to about 6%, 7%, 8%, 9%, 10%, 11%, 12%, 13%, 14%, or 15% (w/w) of hydrocolloid, including any value therebetween. In other embodiments, the baked goods enhancer comprises from about 5% to about 6% (w/w), from about 5% to about 7% (w/w), from about 5% to about 8% (w/w), from about 5% to about 9% (w/w), from about 5% to about 10% (w/w), from about 5% to about 11% (w/w), from about 5% to about 12% (w/w), from about 5% to about 13% (w/w), from about 5% to about 14% (w/w), from about 5% to about 15% (w/w), from about 6% to about 7% (w/w), from about 6% to about 8% (w/w), from about 6% to about 9% (w/w), from about 6% to about 10% (w/w), from about 6% to about 11% (w/w), from about 6% to about 12% (w/w), from about 6% to about 13% (w/w), from about 6% to about 14% (w/w), from about 6% to about 15% (w/w), from about 7% to about 8% (w/w), from about 7% to about 9% (w/w), from about 7% to about 10% (w/w), from about 7% to about 11% (w/w), from about 7% to about 12% (w/w), from about 7% to about 13% (w/w), from about 7% to about 14% (w/w), from about 7% to about 15% (w/w), from about 8% to about 9% (w/w), from about 8% to about 10% (w/w), from about 8% to about 11% (w/w), from about 8% to about 12% (w/w), from about 8% to about 13% (w/w), from about 8% to about 14% (w/w), from about 8% to about 15% (w/w), from about 9% to about 10% (w/w), from about 9% to about 11% (w/w), from about 9% to about 12% (w/w), from about 9% to about 13% (w/w), from about 9% to about 14% (w/w), from about 9% to about 15% (w/w), from about 10% to about 11% (w/w), from about 10% to about 12% (w/w), from about 10% to about 13% (w/w), from about 10% to about 14% (w/w), from about 10% to about 15% (w/w), from about 11% to about 12% (w/w), from about 11% to about 13% (w/w), from about 11% to about 14% (w/w), from about 11% to about 15% (w/w), from about 12% to about 13% (w/w), from about 12% to about 14% (w/w), from about 12% to about 15% (w/w), from about 13% to about 14% (w/w), from about 13% to about 15% (w/w), from about 14% to about 15% (w/w), of hydrocolloid, including any value therebetween.

In still other embodiments, the baked goods composition comprises at least about 5% (w/w), at least about 6% (w/w), at least about 7% (w/w), at least about 8% (w/w), at least about 9% (w/w) at least about 10% (w/w), at least about 11% (w/w), at least about 12%, at least about 13% (w/w), or at least about 14% (w/w) of hydrocolloid, including any value therebetween.

### 4. Insoluble Plant Protein

In some embodiments, the insoluble plant protein is derived from a wheat flour, a rye flour, a maize flour, a barley flour, a quinoa flour, an amaranth flour, or combinations thereof. As used herein, the term “insoluble plant protein” refers to a plant-based protein that only dissolves in about 25 °C water at a concentration of less than 10% w/v, even after 10 minutes.

In some embodiments, the insoluble plant protein is a wheat gluten. In some embodiments including wheat gluten, the wheat gluten has a water binding capacity of from about 1 to about 2 ml/g. In some embodiments including wheat gluten, the wheat gluten has a protein content of from about 65% to about 80% w/w by weight of the wheat gluten.

In some embodiments, the baked goods enhancer composition comprises from about 3% to about 17% (w/w) of an insoluble plant protein. In some embodiments, the baked goods enhancer composition comprises from about 3%, 5%, 8%, 10%, 12%, 14%, 15%, or 16% (w/w) to about 10%, 12%, 14%, 15%, 16%, or 17% (w/w) of an insoluble plant protein, including any value therebetween. In other embodiments, the baked goods enhancer composition comprises from about 3% to about 5%, 5% to about 8%, 8% to about 10% (w/w), from about 8% to about 12% (w/w), from about 8% to about 14% (w/w), from about 8% to about 15% (w/w), from about 8% to about 16% (w/w), from about 8% to about 17% (w/w), from about 10% to about 12% (w/w), from about 10% to about 14% (w/w), from about 10% to about 15% (w/w), from about 10% to about 16% (w/w), from about 10% to about 17% (w/w), from about 12% to about 14% (w/w), from about 12% to about 15% (w/w), from about 12% to about 16% (w/w), from about 12% to about 17% (w/w), from about 14% to about 15% (w/w), from about 14% to about 16% (w/w), from about 14% to ab out 17% (w/w), from about 15% to about 16% (w/w), from about 15% to about 17% (w/w), from about 16% to about 17% (w/w) of an insoluble plant protein, including any value therebetween.

In still other embodiments, the baked goods enhancer composition comprises at least about 3% (w/w), at least about 5% (w/w), at least about 8% (w/w), at least about 10% (w/w), at least about 12% (w/w), at least about 14% (w/w), at least about 15% (w/w), at least about 16% (w/w) of an insoluble plant protein, including any value therebetween.

In some embodiments, the weight ratio of soluble plant protein to insoluble plant protein is about 9:1 to about 0.5:1, preferably about 6:1 to about 1:1, and more preferably about 3:1 to about 1.4:1.

### 5. Hydrolytic Enzyme

In some embodiments, the hydrolytic enzyme includes a lipase, a phospholipase, an amylase, a xylanase, a cellulase, and/or combinations thereof. As used herein, the term “hydrolytic enzyme” refers to an enzyme described as a hydrolase by the Nomenclature Committee of the International Union of Biochemistry and Molecular Biology (IUBMB) and hydrolase enzyme names include: an EC (Enzyme Commission) number in EC Class 3. Enzymes in EC Class 3 can include lipases and phospholipases (EC 3.1), amylases and cellulases, (EC 3.2), and xylanases (EC 3.2).

Various lipases including various phospholipases, triacylglycerol lipases, and galactolipases have been identified from plants; mammals; and microorganisms including but not limited to: Pseudomonas, Vibrio, Acinetobacter, Burkholderia, Chromobacterium, Cutinase from Fusarium solani (FSC), Candida antarctica A (CalA), Rhizopus oryzae (ROL), Thermomyces lanuginosus (TLL) Rhizomucor miehei (RML), Aspergillus Niger, Fusarium heterosporum, Fusarium oxysporum, Fusarium culmorum lipases.

In some embodiments, the amylase has an optimum temperature of about 45 °C to about 75 °C, preferably about 50 °C to about 65 °C, and more preferably about 50 °C to about 60 °C. In some embodiments, the amylase has an optimum temperature of about 30 °C to about 65 °C, preferably about 35 °C to about 50 °C, and more preferably about 35 °C to about 40 °C. Alternatively or additionally, the lipase preferably has an optimum pH of about 7.0 to about 9.0, more preferably about 7.0 to about 8.0, and even more preferably about 7.3 to about 7.7.

Additionally, many lipases, phospholipases, and galactolipases have been disclosed in patents and published patent applications including, but not limited to: WO1993/000924, WO2003/035878, WO2003/089620, WO2005/032496, WO2005/086900, WO2006/031699, WO2008/036863, and WO2011/046812, each of which is incorporated by reference herein.

Suitable commercial lipases can include, but are not limited to: LIPOPAN™, NOOPAZYME, (available from Novozymes); PANAMORE, CAKEZYME, CAKEZYME SUBLIME, and BAKEZYME (available from DSM); and GRINDAMYL EXEL 16, GRINDAMYL POWERBAKE, and TS-E 861 (available from Dupont/Danisco).

Lipolytic enzyme (including lipase and phospholipase enzymes) enzyme activity can be defined in KLUs (kilo lipase units; 1000*LU), CLUs (centi lipase units; 100*LU) or LUs (lipase units) which are defined such that one LU is the amount of enzyme that will generate 1.0 μmole of glycerol from triglycerides per minute (at 37 °C, pH of 7.5, and reaction time of 30 min) when measured in a colorimetric assay using a spectrophotometer using defined standard conditions.

These inventors have determined that lipolytic enzymes having an effective amount of from about 2 KLU to about 4 KLU, preferably about 2.5 KLU to about 3.5 KLU, and more preferably about 2.55 KLU to about 3.35 KLU when added to a baked goods enhancer composition can help maintain the structural characteristics and eating qualities of the baked goods. In some embodiments, the effective amount of lipolytic enzymes can be from about 2.5, 2.6, 2.7, 2.8, 2.9, 3.0, 3.1, 3.2, 3.3, or 3.4 KLU to about 2.6, 2.7, 2.8, 2.9, 3.0, 3.1, 3.2, 3.3, 3.4, or 3.5 KLU/.

As used herein, “effective amount” refers to the enzyme activity units (expressed in KLU/gm, MANU/gm, or NBXU/gm) multiplied by the weight amount of the enzyme in grams. For example, if an enzyme (e.g., a lipase) has an activity of 50 KLU/gm, and 0.51 grams of the enzyme is used, the effective amount of that enzyme is 2.55 KLU. If more than one enzyme of a particular enzyme type is included in a formulation (e.g., two or more different lipases are included in a formulation), the effective amount of lipolytic enzymes is the sum of the effective amount of each individual lipase type.

Similarly, various amylases include fungal amylases, bacterial alpha-amylase from Bacillus subtilis, alpha amylases, maltogenic alpha amylases, and non-maltogenic amylases. Some maltogenic alpha-amylases are described as enzymes that are able to hydrolyze amylose and amylopectin to maltose in the alpha-configuration. Some amylase enzymes can include starch degrading enzymes that operate on baked goods to generate simple sugars to aid in yeast-raising as well as providing other benefits.

In some embodiments, the amylase has an optimum temperature of about 50 °C to about 75 °C, preferably about 50 °C to about 65 °C, and more preferably about 50 °C to about 60 °C. In some embodiments, the amylase has an optimum temperature of about 30 °C to about 75 °C, preferably about 35 °C to about 50 °C, and more preferably about 35 °C to about 40 °C. Alternatively or additionally, the amylase preferably has an optimum pH of about 4.0 to about 6.0, more preferably about 4.5 to about 5.5, and even more preferably about 4.8 to about 5.2.

Maltogenic amylase can preferably include a maltogenic a-amylase, and even more preferably a maltogenic a-exoamylase. One such preferred amylase is sold under the name NOVAMYL by Novozymes A/S and is described in U.S. Pat. No. RE38,507, incorporated by reference herein. This maltogenic amylase is producible by Bacillus strain NCIB 11837, or one encoded by a DNA sequence derived from Bacillus strain NCIB 11837 (the maltogenic amylase is disclosed in U.S. Pat. Nos. 4,598,048 and 4,604,355, the contents of which are incorporated herein by reference).

Another maltogenic amylase which may be used in these inventions is a maltogenic β-amylase, producible by Bacillus strain NCIB 11608 (disclosed in EP 234 858, the contents of which are hereby incorporated by reference). Another suitable enzyme for use in these inventions is available from DuPont Danisco under the names POWERFresh® G4 and POWERFresh® G+. Additionally, U.S. Patent Application Publication No. 2009/0297659 (incorporated by reference herein) discloses suitable amylases.

Suitable amylases can also include NOVAMYL® and OPTICAKE® 50BG (both available from Novozymes A/S). Such amylases have been described in EP120693, WO2006/032281 and WO1999/43794. Some amylases have been described as providing an anti-staling benefit to baked goods.

The maltogenic amylase catalyzes the hydrolysis of (1→4)-α-d-glucosidic linkages in amylose, amylopectin and related glucose polymers, liberating maltose units from the non-reducing end of the polymer chain.

The enzymatic activity of maltogenic amylases can be determined on the basis of a method using a maltotriose standard and expressed in Maltogenic Amylase Novo Units/gm (MANU/gm). One MANU is defined as the amount of enzyme that produces 1 μmol glucose per minute using maltotriose as substrate under the defined assay conditions (reaction conditions: pH=5.0, T=37 °C, incubation time 30 min). The enzymatic hydrolysis of maltotriose results in the release of glucose, which is determined quantitatively using a glucose hexokinase assay.

Advantageously, the effective amount (as defined previously) of maltogenic amylase in the baked goods enhancer composition can be from about 500 to about 1,300 MANU, preferably from about 600 to about 1,200 MANU, and more preferably from about 720 to about 1,020 MANU. In some embodiments, the effective amount of maltogenic amylase can be from about 600, 650, 700, 750, 800, 850, 900, 950, 1,000, 1,050, 1,100, or 1,150 MANU, to about 650, 700, 750, 800, 850, 900, 950, 1,000, 1,050, 1,100, 1,150, or 1,200 MANU.

As to cellulases, some embodiments include a cellulase, such as beta-glucanase, cellulase, cellobiohydrolase and/or beta-glucosidase. In some embodiments, a cellulase preparation is a complex of cellulases and/or hemicellulases, preferably obtained from Trichoderma sp., more preferably from T. reesei. Also preferred are cellulase preparations obtained from Aspergillus, preferably obtained from A. niger. A suitable cellulase composition may be CELLUCLAST™ (available from Novozymes) or Bakezyme® XU, Bakezyme® XE, BakeZyme® X-cell or Bakezyme® W (all available from DSM).

Xylanases in some embodiments can be of microbial origin, e.g., derived from a bacterium or fungus, such as a strain of Aspergillus, in particular of A. aculeatus, A. niger, A. awamori, or A. tubigensis, or from a strain of Trichoderma, e.g., T. reesei, or from a strain of Humicola, e.g., H. insolens.

In some embodiments, the xylanase has an optimum temperature of about 50 °C to about 85 °C, preferably about 55 °C to about 75 °C, and more preferably about 60 °C to about 70 °C. In some embodiments, the xylanase has an optimum temperature of about 25 °C to about 65 °C, preferably about 25 °C to about 50 °C, and more preferably about 25 °C to about 35 °C. Alternatively or additionally, the xylanase preferably has an optimum pH of about 6.0 to about 9.0, more preferably about 6.0 to about 7.0, and even more preferably about 5.8 to about 6.2.

The enzymatic activity of xylanases can be determined based on hydrolysis of wheat arabinoxylan (reaction conditions: pH 6, 30 °C, 30 min). The enzymatic activity is determined by measuring the release of reducing groups, with a hexacyanoferrate reagent (Hoffman reagent) which is measured spectrophotometrically at 420 nm. The enzyme activity is expressed in New Bakery Xylanase Units (NBXU/gm). One NBXU is defined as the amount of enzyme that produces 0.5 mg of xylose equivalents under the assay conditions.

Advantageously, the effective amount (as defined previously) of xylanase in the baked goods enhancer composition can be from about 20 to about 350 NBXU, preferably from about 20 to about 275 NBXU, more preferably from about 100 to about 275 NBXU, and even more preferably from about 150 to about 275 NBXU. In some embodiments, the effective amount of xylanase can be from about 20, 50, 75, 100, 125, 150, 175, 200, 225, or 250 NBXU to about 50, 75, 100, 125, 150, 175, 200, 225, 250, or 275 NBXU.

Suitable commercially available xylanase preparations for use in these inventions include PANZEA BG™, PENTOPAN MONO BG™ and PENTOPAN 500 BG™ (available from Novozymes MS), GRINDAMYL POWERBAKE™ (available from Danisco), and BAKEZYME BXP 5000™ and BAKEZYME BXP 5001™ (available from DSM).

In some embodiments, the hydrolytic enzyme includes a blend of enzymes. In embodiments including an enzyme blend, the blend can include each of an amylase(s) (preferably a maltogenic amylase), a lipase(s), and a xylanase(s). In such three-way enzyme blends, the enzyme blend can include total maltogenic amylase levels in an amount of from about 30 parts to about 60 parts of the enzyme blend, and preferably from about 30 parts to about 50 parts, wherein the maltogenic amylase has an effective amount of from about 500 to about 1,300 MANU, preferably from about 600 to about 1,200 MANU, and more preferably from about 720 to about 1,020 MANU.

Additionally or alternatively, the enzyme blend can include total lipase levels in an amount of from about 30 parts to about 60 parts of the enzyme blend, and preferably from about 40 parts to about 60 parts, wherein the lipase has an effective amount of from about 2 to about 4 KLU, preferably from about 2.5 to about 3.5 KLU, and more preferably from about 2.55 to about 3.35 KLU.

Additionally or alternatively, the enzyme blend can include total xylanase levels in an amount of from about 6 parts to about 10 parts of the enzyme blend, and preferably from about 7 parts to about 10 parts, wherein the xylanase has an effective amount of from about 20 to about 275 NBXU, preferably from about 100 to about 275 NBXU, and more preferably from about 150 to about 275 NBXU.

In some embodiments the ratio of the effective amount of maltogenic amylase to the effective amount of lipase can be from about 150:1 to about 500:1, preferably about 200:1 to about 450:1, and more preferably about 200:1 to about 300:1.

Additionally or alternatively, the ratio of the effective amount of maltogenic amylase to the effective amount of xylanase can be from about 1.5:1 to about 7:1, preferably about 2:1 to about 6:1, and more preferably about 3:1 to about 5:1.

In some embodiments the ratio of the effective amount of xylanase to the effective amount of lipase can be from about 30:1 to about 200:1, preferably about 40:1 to about 150:1, and more preferably about 50:1 to about 100:1.

In some embodiments where the baked goods enhancer composition includes a three-way enzyme blend comprising a amylase (and particularly a maltogenic amylase), a lipase, and a xylanase, the three-way enzyme blend can include a weight ratio of amylase to lipase of from about 0.25:1 to about 4:1, preferably from about 0.5:1 to about 2:1, and more preferably from about 0.6:1 to about 1.2:1, wherein the maltogenic amylase has an enzyme activity of from about 10,000 MANU/gm to about 30,000 MANU/gm, preferably from about 15,000 MANU/gm to about 25,000 MANU/gm, and more preferably about 19,000 MANU/gm to about 21,000 MANU/gm, and the lipase has an enzyme activity of from about 25 to about 75 KLU/gm, preferably about 35 to about 65 KLU/gm, and more preferably about 45 to about 55 KLU/gm.

Additionally or alternatively, the weight ratio of amylase (and particularly maltogenic amylase) to xylanase can be from about 1.5:1 to about 8:1, preferably about 2:1 to about 7:1, and more preferably about 3.5:1 to about 5.5:1 wherein the maltogenic amylase has an enzyme activity of from about 10,000 MANU/gm to about 30,000 MANU/gm preferably from about 15,000 MANU/gm to about 25,000 MANU/gm, and more preferably about 19,000 MANU/gm to about 21,000 MANU/gm, and the xylanase has an enzyme activity of from about 15,000 to about 35,000 NBXU/gm, preferably from about 20,000 to about 30,000 NBXU/gm, and more preferably from about 23,000 to about 27,000 NBXU/gm.

In some embodiments the weight ratio of lipase to xylanase can be from about 1.5:1 to about 8:1, preferably about 2:1 to about 7:1, and more preferably about 3.5:1 to about 5.5:1, wherein the lipase has an enzyme activity of from about 25 to about 75 KLU/gm, preferably about 35 to about 65 KLU/gm, and more preferably about 45 to about 55 KLU/gm, and the xylanase has an enzyme activity of from about 15,000 to about 35,000 NBXU/gm, preferably from about 20,000 to about 30,000 NBXU/gm, and more preferably from about 23,000 to about 27,000 NBXU/gm.

While the use of enzymes to enhance various properties of baked goods has been previously described, the use of enzymes combined with pulse flour, soluble plant protein, hydrocolloid and insoluble plant protein to reduce amounts of whole eggs and oil in baked goods thereby enhancing the nutritional and other characteristics of baked goods has not been previously described.

### 6. Additional Ingredients

In some embodiments, the baked goods enhancer can include additional ingredients such as colors or coloring agents, flavors or flavoring agents, and/or other functional ingredients. For example, if incorporation of the inventive baked goods enhancer results in a food product with a less than desirable color because of the egg reduction in the food product, the baked goods enhancer and/or the food product adjusted formulation can include a color ingredient. In some embodiments, the additional color material is an artificial and/or natural yellow and/or orange color. Additional ingredients that contribute yellow and/or orange color can include, but are not limited to a carotenoid, a lycopene, an annatto, a turmeric extract, a paprika extract, a saffron extract, a carrot extract, a sweet potato extract, a riboflavin, a curcumin (E100), an FD&C Orange B, a tartrazine (FD&C Yellow No. 5 and E102), a sunset yellow FCF (orange yellow S and FD&C Yellow No. 6 and E110), a quinoline yellow (E104), or mixtures thereof.

As to additional fibers and bulking agents, soluble and insoluble fibers can be added to improve flowability of the baked goods enhancer composition and to enhance the textural and sensory properties of food products including the baked goods enhancer composition. Suitable fibers and bulking agents can include, but are not limited to, inulin, arabinoxylans, psyllium husk, beta-glucan, and/or combinations thereof. In some embodiments, the additional fibers and bulking agents can include cereal fibers, brans such as oat bran, wheat bran, and the like, and/or combinations thereof. Additionally, blends of soluble and insoluble fibers can be used in some embodiments.

As to emulsifiers (also referred to as emulsifying agents), suitable materials can include polyglycerol esters, sorbitan esters, monoglycerides, mono & diglycerides, sodium stearoyl lactylate (SSL), lecithin, and the like, and/or combinations thereof.

As to leavening agents, these are materials that can cause the food products (especially baked goods) to rise or increase in volume. Suitable leavening agents can include, but are not limited to, sodium bicarbonate (i.e., as in household baking powder, alone or combined with at least one acid), yeast, sourdough starter, sodium acid pyrophosphate (also known as disodium pyrophosphate), or combinations of these materials.

Regardless of whether any such “additional ingredients” are included, in some embodiments, the disclosed baked goods enhancer composition is substantially free of fats and oils. That is, in one or more embodiments, the baked goods enhancer composition comprises less than about 3% (w/w) total fat and oil, preferably less than about 2% (w/w) total fat and oil, more preferably less than about 1% (w/w) total fat and oil, and even more preferably about 0% (w/w) total fat and oil.

In the same or different embodiments, the baked goods enhancer composition is preferably free of emulsifiers (e.g., polyglycerol esters, sorbitan esters, monoglycerides, mono & diglycerides, sodium stearoyl lactylate, lecithin). Thus, in these embodiments, the baked goods enhancer composition comprises less than about 3% (w/w) emulsifiers, preferably less than about 2% (w/w) emulsifiers, more preferably less than about 1% (w/w) emulsifiers, and even more preferably about 0% (w/w) emulsifiers.

In some embodiments, the baked goods enhancer composition is preferably free of microalgae. As used herein, “microalgae” includes both eukaryotic microalgae, which are characterized by a nucleus, and prokaryotic microalgae, which do not have a nucleus. In these embodiments, the baked goods enhancer composition comprises less than about 3% (w/w) microalgae, preferably less than about 2% (w/w) microalgae, more preferably less than about 1% (w/w) microalgae, and even more preferably about 0% (w/w) microalgae.

In some embodiments, the baked goods enhancer composition is preferably free of golden flaxseed. In these embodiments, the baked goods enhancer composition comprises less than about 3% (w/w) golden flaxseed, preferably less than about 2% (w/w) golden flaxseed, more preferably less than about 1% (w/w) golden flaxseed, and even more preferably about 0% (w/w) golden flaxseed. In some embodiments, the baked goods enhancer composition comprises less than about 3% (w/w) flaxseed (of any kind), preferably less than about 2% (w/w) flaxseed, more preferably less than about 1% (w/w) flaxseed, and even more preferably about 0% (w/w) flaxseed.

In some embodiments, the baked goods enhancer composition is preferably free of crosslinking enzymes. In such embodiments, the baked goods enhancer composition comprises less than about 2% (w/w) crosslinking enzymes, preferably less than about 1% (w/w) crosslinking enzymes, more preferably less than about 0.05% (w/w) crosslinking enzymes, and even more preferably about 0% (w/w) crosslinking enzymes. Crosslinking enzymes as used herein include a transglutaminase enzyme. Transglutaminases fall under the EC class 2, in particular EC 2.3.2.13. These enzymes catalyze the formation of covalent bonds between the γ-carboxamide groups of protein- or peptide-bound glutamine (acyl donors) and the free amine groups of protein- or peptide-bound lysine (acyl acceptors). Their action in forming these covalent bond tends to be irreversible.

In some embodiments, the baked goods enhancer composition consists essentially of, or even consists of, a pulse flour, a soluble plant protein, a hydrocolloid, an insoluble plant protein, and a hydrolytic enzyme.

In some embodiments, the baked goods enhancer composition consists essentially of, or even consists of, a pulse flour, a soluble plant protein, a hydrocolloid, an insoluble plant protein, a hydrolytic enzyme, and an additional ingredient chosen from coloring agents, flavoring agents, fibers, bulking agents, emulsifiers, leavening agents, or combinations thereof.

In some embodiments, the baked goods enhancer composition consists essentially of, or even consists of, a pulse flour, a soluble plant protein, a hydrocolloid, an insoluble plant protein, and a hydrolytic enzyme blend.

In some embodiments, the baked goods enhancer composition consists essentially of, or even consists of, a pulse flour, a soluble plant protein, a hydrocolloid, an insoluble plant protein, a hydrolytic enzyme blend, and an additional ingredient chosen from coloring agents, flavoring agents, fibers, bulking agents, emulsifiers, leavening agents, or combinations thereof.

In some embodiments, the baked goods enhancer composition consists essentially of, or even consists of, a pulse flour, a soluble plant protein, a hydrocolloid, an insoluble plant protein, a maltogenic amylase, a lipase, and a xylanase.

In some embodiments, the baked goods enhancer composition consists essentially of, or even consists of, a pulse flour, a soluble plant protein, a hydrocolloid, an insoluble plant protein, a maltogenic amylase, a lipase, a xylanase, and an additional ingredient chosen from coloring agents, flavoring agents, fibers, bulking agents, emulsifiers, leavening agents, or combinations thereof.

### Food Products

In addition to the baked goods enhancer composition described herein, these inventors have also developed food product compositions that include the baked goods enhancer composition. In some embodiments, a food product comprises about 0.01% to about 20% of a baked goods enhancer composition (% w/w by weight of the food product). In some preferred embodiments, the food product comprises from about 5% to about 15% of a baked goods enhancer and other more preferred embodiments, the food product comprises from about 7.5% to about 13.5% of a baked goods enhancer (% w/w by weight of the food product). In other embodiments, the food product is a baked good and comprises from about 0.01% to about 10% baked goods enhancer composition (% w/w by weight of flour in the baked good). In still other baked good embodiments, the baked good comprises from about 0.25% to about 2.50% baked goods enhancer composition (% w/w by weight of the flour in the baked good). In these food product embodiments, the baked goods enhancer composition comprises from about 45% to about 70% of a pulse flour, from about 10% to about 25% of a soluble plant protein, from about 5% to about 15% of a hydrocolloid, from about 3% to about 17% of an insoluble plant protein, and from about 0.01 to about 0.20% of a hydrolytic enzyme.

As used herein, the term “whole egg” refers to eggs products as described in 21 C.F.R § 160.105, § 160.110, and § 160.115 or combinations thereof. Food products including the inventive baked goods enhancer composition can have sensory properties that are not significantly different from the food products without the adjustment to reduce the amounts of whole eggs and oil as measured by sensory testing. Sensory test can include typical difference tests such as duo-trio tests, triangle tests, and the like. In some embodiments, the food product has no whole egg.

In some embodiments, food products comprising the disclosed baked goods enhancer composition are substantially free of fats and oils. That is, in one or more embodiments, such food products comprise less than about 3% (w/w) total fat and oil, preferably less than about 2% (w/w) total fat and oil, more preferably less than about 1% (w/w) total fat and oil, and even more preferably about 0% (w/w) total fat and oil.

In the same or different embodiments, food products comprising the baked goods enhancer composition are preferably free of emulsifiers (e.g., polyglycerol esters, sorbitan esters, monoglycerides, mono & diglycerides, sodium stearoyl lactylate, lecithin). Thus, in these embodiments, food products formed using the baked goods enhancer composition comprise less than about 3% (w/w) emulsifiers, preferably less than about 2% (w/w) emulsifiers, more preferably less than about 1% (w/w) emulsifiers, and even more preferably about 0% (w/w) emulsifiers.

In some embodiments, food products comprising the baked goods enhancer composition are preferably free of microalgae, defined previously. In these embodiments, these food products comprise less than about 3% (w/w) microalgae, preferably less than about 2% (w/w) microalgae, more preferably less than about 1% (w/w) microalgae, and even more preferably about 0% (w/w) microalgae.

In some embodiments, food products formed using the disclosed baked goods enhancer composition are preferably free of golden flaxseed. In these embodiments, these food products comprise less than about 3% (w/w) golden flaxseed, preferably less than about 2% (w/w) golden flaxseed, more preferably less than about 1% (w/w) golden flaxseed, and even more preferably about 0% (w/w) golden flaxseed. In some embodiments, these food products comprise less than about 3% (w/w) flaxseed (of any kind), preferably less than about 2% (w/w) flaxseed, more preferably less than about 1% (w/w) flaxseed, and even more preferably about 0% (w/w) flaxseed.

In one or more embodiments, food products formed using the disclosed baked goods enhancer composition are preferably free of crosslinking enzymes, as defined previously. In such embodiments, these food products and/or the ingredients used to make those food products comprise less than about 2% (w/w) crosslinking enzymes, preferably less than about 1% (w/w) crosslinking enzymes, more preferably less than about 0.05% (w/w) crosslinking enzymes, and even more preferably about 0% (w/w) crosslinking enzymes.

A significant advantage of the disclosed baked goods enhancer composition is that it provides structure to the food product. Food products such as baked breads show improved loaf height and/or bread volume as compared to other baked goods enhancers. Food products such as sweet baked goods show improved air cell size, cake height, and/or cake volume as compared to other baked goods enhancers. It will be appreciated that these properties are similar to the results achieved with real eggs and/or oils/fats.

In some embodiments, another advantageous property provided to the food products by the baked goods enhancer composition is that of gas retention and textural attributes such as desirable elasticity including bakery products like breads, and sweet baked goods such as various types of cakes, including but not limited to pound cake, sponge cake, chiffon cake, cheesecake, sheet cake, fruit cake, layer cake, and/or gingerbread cake.

### Methods of Making and Using Baked Good Compositions

In some embodiments, these inventors have developed a method of making a baked goods enhancer composition, with the method comprising mixing the pulse flour, soluble plant protein, hydrocolloid, insoluble plant protein, hydrolytic enzyme(s), and any additional ingredients until homogeneous.

In one or more embodiments, this method comprises combining from about 45% to about 70% of a pulse flour, from about 10% to about 25% of a soluble plant protein, from about 5% to about 15% of a hydrocolloid, from about 3% to about 17% of an insoluble plant protein, and from about 0.01 to about 0.20% of a hydrolytic enzyme to a blender (preferably a dry blender) and blending until homogeneous. In some embodiments, the dry blending step can include the use of various types of dry blending equipment, including but not limited to, V-blenders, ribbon blenders, paddle blenders, and the like. In some embodiments, the powder blending can be done via a batch process while in other embodiments, the powder blending can be a continuous process.

In embodiments involving methods of adjusting a food formulation, the amount of whole eggs in the food formulation can be reduced by an amount of from about 20% to about 50% by replacing that amount of whole eggs with an amount of from about 0.01% to about 20% of a baked goods enhancer composition (% w/w by weight of the food product) comprising from about 45% to about 70% of a pulse flour, from about 10% to about 25% of a soluble plant protein, from about 5% to about 15% of a hydrocolloid, from about 3% to about 17% of an insoluble plant protein, and from about 0.01 to about 0.20% of a hydrolytic enzyme wherein all percentages are w/w by weight of the baked goods enhancer composition.

In addition to reducing the amount of whole eggs in a food formulation, the methods of adjusting a food formulation can further comprise replacing from about 20% to about 50% of an amount of oil in the food formulation with an amount of from about 0.01% to about 20% of a baked goods enhancer composition (% w/w by weight of the food product) comprising from about 45% to about 70% of a pulse flour, from about 10% to about 25% of a soluble plant protein, from about 5% to about 15% of a hydrocolloid, from about 3% to about 17% of an insoluble plant protein, and from about 0.01 to about 0.20% of a hydrolytic enzyme wherein all percentages are w/w by weight of the baked goods enhancer composition. This dual adjustment of reducing the whole eggs and the oil amounts improves the food formulation from both an operational and a nutritional perspective.

Non-limiting examples of food products that can benefit from this food formulation adjustment benefit can include baked and sweet baked goods, such as but not limited to muffins, croissants, buns, rolls, snack cakes, crackers, donuts, biscuits, cookies, cupcakes, brownies, cakes including sheet cakes, pound cakes, sponge cakes, chiffon cakes, cheesecakes, fruit cakes, layer cakes and gingerbread cakes and the like, pancakes, breads, waffles, pastries, pies, tarts, scones, pretzels, and the like.

In some embodiments, a method of making a food product includes adding from about 0.01% to about 20% w/w by weight of the food product of a baked goods enhancer composition comprising from about 45% to about 70% of a pulse flour, from about 10% to about 25% of a soluble plant protein, from about 5% to about 15% of a hydrocolloid, from about 3% to about 17% of an insoluble plant protein, and from about 0.01 to about 0.20% of a hydrolytic enzyme to a food formulation. In some embodiments, the food formulation includes a muffin, a croissant, a biscuit, a cookie, a cupcake, a brownie, a cake, a pancake, a bread, a waffle, a pastry, a pie, a tart, a scone, a pretzel, or combinations thereof. In some embodiments, the method of making a food product does not require any changes to the unit operations of the food product manufacturing process when using the inventive baked goods enhancer composition. This operational simplicity is another advantage of the baked goods enhancer inventions.

### GENERAL

The terms “comprises,” “comprising,” “includes,” “including,” “having,” and their conjugates mean “including but not limited to.”

For ranges described herein, it should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

As used herein the term “method” refers to manners, means, techniques and procedures for accomplishing a given task including, but not limited to, those manners, means, techniques and procedures either known to, or readily developed from known manners, means, techniques and procedures by those of skill in the art.

### EXAMPLES

Reference is now made to the following examples, which together with the above descriptions illustrate some embodiments of the invention in a non-limiting fashion.

### Example 1

### Baked Goods Enhancer Composition Mixtures

TABLE 1
Baked Goods Enhancer Compositions

| Ingredient | Mixture 1¹ | Mixture 2 | Mixture 3 | Mixture 4 |
|---|---|---|---|---|
| Fava bean flour | 59.686 | | 59.686 | 6 |
| Chickpea flour | | 64.686 | | 54.686 |
| Wheat flour | 9 | | 10 | |
| Pea Protein | | 20 | 15 | |
| Rice Protein | 20 | | | 18 |
| Xanthan Gum | 4 | 5 | 10 | |
| Guar Gum | 2 | | | 4 |
| CMC | | 5 | | 10 |
| Gluten | 5 | 5 | 5 | 7 |
| Salt | 0.202 | 0.202 | 0.202 | 0.202 |
| Maltogenic | 0.051 | 0.042 | 0.036 | 0.043 |
| amylase² | | | | |
| Lipase³ | 0.051 | 0.063 | 0.067 | 0.058 |
| Xylanase⁴ | 0.010 | 0.007 | 0.009 | 0.011 |

¹All amounts are % w/w by weight of the Baked Goods Enhancer Composition.
²Can be a NOVAMYL ® enzyme.
³Can be a LIPOPAN ™ enzyme.
⁴Can be a BAKEZYME enzyme.

Mixtures 1-4 are prepared by adding each quantity of material to a Hobart mixing bowl and mixing at low speed for 5 minutes or until homogeneous resulting in a loose, beige powder.

### Example 2

### Baked Goods Food Product

TABLE 2
Mini Muffin

| Ingredient | Comparative Wt. % | Inventive Wt. % |
|---|---|---|
| Cake Flour | 16.43 | 19.09 |
| Granulated sugar | 17.46 | 17.73 |
| Muffin Base 10 2.0¹ | 10.27 | 10.43 |
| Sorbic acid | 0.21 | 0.21 |
| Potassium sorbate | 0.10 | 0.10 |
| Ultra Fresh Sweet 290² | 0.164 | 0.167 |
| Baked Goods Enhancer | | 1.10 |
| Composition Mixtures 1-4 | | |
| Water | 10.78 | 19.30 |
| Liquid whole egg | 18.49 | 12.51 |
| Corn Syrup | 4.11 | 4.17 |
| Glycerin | 3.08 | 3.12 |
| Soybean oil | 17.97 | 12.20 |
| Soft Touch³ | 0.92 | 0.94 |
| Total | 100 | 100 |

¹This cake mix is available from Corbion.
²This enzyme blend is available from Corbion.
³This emulsifier is available from Corbion.

### Mixing & Baking Instructions:

1. Add soybean oil, glycerin, corn syrup, Soft Touch, and one half of the water for mixtures to bowl and mix until homogeneous.
2. Add dry ingredients to bowl. Mix for 1 minute on 1st speed, then 1 minute on 2nd speed.
3. Add remaining water while mixing for 1 minute on 1^{st} speed, scrape well, then mix 2 minutes 1^{st} speed.
4. Pour into suitable pans and bake at 350 °F (176.7 °C) until done.

Using Mixtures 1-4 allows for a 32% reduction in the amount of whole egg and a 32% reduction in the amount of oil in the Inventive Mini Muffins as compared to the Comparative Mini Muffins.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A baked goods enhancer composition comprising from about 45% to about 70% of a pulse flour, from about 10% to about 25% of a soluble plant protein, from about 5% to about 15% of a hydrocolloid, from about 3% to about 17% of an insoluble plant protein, and from about 0.01 to about 0.20% of a hydrolytic enzyme, wherein all percentages are w/w by weight of the baked goods enhancer composition and the hydrolytic enzyme includes a three-way enzyme blend comprising:
respective effective amounts of each of a maltogenic amylase, a lipase, and a xylanase; and
respective weights of each of a maltogenic amylase, a lipase, and a xylanase, wherein one or both of the following are true:
the ratio of the effective amount of maltogenic amylase to the effective amount of lipase is from about 150:1 to about 500:1; or
the weight ratio of maltogenic amylase to lipase is from about 0.25:1 to about 4:1.

2. The baked goods enhancer composition as in claim 1, wherein the pulse flour includes a lentil flour, a broad bean flour, a chickpea flour, a fava bean flour, a black bean flour, a kidney bean flour, a navy bean flour, a pinto bean flour, a mung bean flour, a lima bean flour, an adzuki bean flour, or combinations thereof.

3-5. (canceled)

6. The baked goods enhancer composition as in claim 1, wherein the soluble plant protein includes a rice protein, a pea protein, a charantia protein, a walnut protein, a corn protein, a mung bean protein, or combinations thereof.

7. The baked goods enhancer composition as in claim 1, wherein the soluble plant protein has a protein content of at least 75%.

8. The baked goods enhancer composition as in claim 1, wherein the soluble plant protein has a viscosity of less than about 550 cps when measured by rotational viscometer in a 10-50% solution.

9. The baked goods enhancer composition as in claim 1, wherein the hydrocolloid can include a xanthan gum, an alginate gum, a carboxymethyl cellulose, a carrageenan gum, a guar gum, an agar gum, or combinations thereof.

10. The baked goods enhancer composition as in claim 1, wherein the insoluble plant protein is derived from a wheat flour, a rye flour, a maize flour, a barley flour, a quinoa flour, an amaranth flour, or combinations thereof.

11. The baked goods enhancer composition as in claim 1, wherein the insoluble plant protein is a wheat gluten.

12. The baked goods enhancer composition as in claim 11, wherein the wheat gluten has a water binding capacity of from about 1 to about 2 ml/g.

13. The baked goods enhancer composition as in claim 11, wherein the wheat gluten has a protein content of from about 70% to about 80% w/w by weight of the wheat gluten.

14. The baked goods enhancer composition as in claim 1, wherein the weight ratio of pulse flour to insoluble plant protein is from about 2.3 to about 4:1.

15. (canceled)

16. A food product comprising from about 0.01% to about 20% of a baked goods enhancer composition, based on w/w by weight of the food product, said baked goods enhancer comprising from about 45% to about 70% of a pulse flour, from about 10% to about 25% of a soluble plant protein, from about 5% to about 15% of a hydrocolloid, from about 3% to about 17% of an insoluble plant protein, and 0.01 to about 0.20% of a hydrolytic enzyme, based on w/w by weight of the baked goods enhancer composition, wherein the hydrolytic enzyme includes a three-way enzyme blend comprising:
respective effective amounts of each of a maltogenic amylase, a lipase, and a xylanase; and
respective weights of each of a maltogenic amylase, a lipase, and a xylanase, wherein one or both of the following are true:
the ratio of the effective amount of maltogenic amylase to the effective amount of lipase is from about 150:1 to about 500:1; or
the weight ratio of maltogenic amylase to lipase is from about 0.25:1 to about 4:1.

17. (canceled)

18. A baked goods enhancer composition comprising a pulse flour, a soluble plant protein, an insoluble plant protein, a hydrocolloid, and a hydrolytic enzyme chosen from maltogenic amylases, lipases, xylanases, or combinations thereof.

19. (canceled)

20. The baked goods enhancer composition of claim 18, wherein said hydrolytic enzyme comprises a blend comprising respective effective amounts of each of a maltogenic amylase, a lipase, and a xylanase.

21. The baked goods enhancer composition of claim 20, wherein one of the following is true:
(a) the ratio of the effective amount of maltogenic amylase to the effective amount of lipase is from about 150:1 to about 500:0;
(b) the ratio of the effective amount of maltogenic amylase to the effective amount of xylanase is from about 1.5:1 to about 7:0;
(c) the ratio of the effective amount of xylanase to the effective amount of lipase is from about 30:1 to about 200:0;
(d) both (a) and (b);
(e) both (b) and (c):
(f) both (a) and (c); or
(g) each of (a), (b), and (c).

22. The baked goods enhancer composition of claim 18, wherein said hydrolytic enzyme comprises a blend comprising each of a maltogenic amylase, a lipase, and a xylanase, wherein said blend comprises one of the following:
(a) an effective amount of maltogenic amylase of about 500 to about 1,300 MANU;
(b) an effective amount of lipase of about 2 KLU to about 4 KLU;
(c) an effective amount of xylanase of about 20 to about 350 NBXU;
(d) both (a) and (b);
(e) both (b) and (c):
(f) both (a) and (c); or
(g) each of (a), (b), and (c).

23-27. (canceled)

28. The baked goods enhancer composition of claim 18, wherein the soluble plant protein is chosen from a rice protein, a pea protein, a charantia protein, a walnut protein, a corn protein, a mung bean protein, or combinations thereof.

29. The baked goods enhancer composition of claim 18, wherein the insoluble protein is derived from wheat flour, rye flour, maize flour, barley flour, quinoa flour, amaranth flour, or combinations thereof.

30-34. (canceled)

35. A food product comprising the baked goods enhancer composition according to claim 18.

36. The food product of claim 35, wherein the food product is selected from the group consisting of muffins, croissants, buns, rolls, snack cakes, crackers, donuts, biscuits, cookies, cupcakes, brownies, cakes, pancakes, breads, waffles, pastries, pies, tarts, scones, and pretzels.
